(19) United States
(12) Patent Application Publication
(10) Pub. No.: US 2025/0227641 A1
(43) Pub. Date: Jul. 10, 2025

(54) METHOD FOR TIMING ADJUSTMENT, COMMUNICATION APPARATUS AND NON-TRANSITORY COMPUTER-READABLE STORAGE MEDIUM

(71) Applicant: BEIJING XIAOMI MOBILE SOFTWARE CO., LTD., Beijing (CN)

(72) Inventor: Xuhua TAO, Beijing (CN)

(73) Assignee: BEIJING XIAOMI MOBILE SOFTWARE CO., LTD., Beijing (CN)

(21) Appl. No.: 18/846,956

(22) PCT Filed: Mar. 14, 2022
(86) PCT No.: PCT/CN2022/080698

§ 371 Date: Sep. 13, 2024

(51) Int. Cl. H04W 56/00; H04W 64/00; H04W 76/20

(52) U.S. Cl. CPC H04W 56/0045; H04W 64/006; H04W 76/20

(57) ABSTRACT

A method for timing adjustment, performed by a user equipment (UE), includes: obtaining information sent by a network device; determining a timing adjustment scheme based on the information; and adjusting an uplink transmission timing of the UE based on the timing adjustment scheme.

### CROSS REFERENCE TO RELATED APPLICATIONS

The present application is a U.S. National Stage of International Application No. PCT/CN2022/080698, filed on Mar. 14, 2022, all contents of which are incorporated herein by reference in their entireties for all purposes.

### TECHNICAL FIELD

The present disclosure relates to the field of communication technology, and in particular, to a method for timing adjustment/apparatus/device and a non-transitory computer-readable storage medium.

### BACKGROUND

In the communication system, the actual up transmission timing determined by a UE (User Equipment) usually needs to be adjusted by using a timing adjustment rule, so that the error between the actual up transmission timing and the theoretical uplink transmission timing is within a plus or minus predetermined duration Te.

### SUMMARY

According to embodiments of a first aspect of the present disclosure, there is provided a method for timing adjustment, performed by a UE, and including:
obtaining information sent by a network device;
determining a timing adjustment scheme based on the information; and
adjusting an uplink transmission timing of the UE based on the timing adjustment scheme.

According to embodiments of a second aspect of the present disclosure, there is provided a method for timing adjustment, performed by a network device, and including:
sending information to a UE, where the information is used for the UE to determine a timing adjustment scheme.

According to embodiments of another aspect of the present disclosure, there is provided a communication apparatus, where the apparatus includes a processor and a memory, the memory stores a computer program, and the processor executes the computer program stored in the memory to enable the apparatus to perform the method according to the embodiments of the first aspect.

According to embodiments of still another aspect of the present disclosure, there is provided a communication apparatus, where the apparatus includes a processor and a memory, the memory stores a computer program, and the processor executes the computer program stored in the memory to enable the apparatus to perform the method according to the embodiments of the second aspect.

According to embodiments of still another aspect of the present disclosure, there is provided a non-transitory computer-readable storage medium, configured to store an instruction, and when the instruction is executed, the method provided to the embodiments of the first of the present disclosure is implemented.

According to embodiments of still another aspect of the present disclosure, there is provided a non-transitory computer-readable storage medium, configured to store an instruction, and when the instruction is executed, the method provided to the embodiments of the second aspect of the present disclosure is implemented.

### BRIEF DESCRIPTION OF THE DRAWINGS

The above and/or additional aspects and advantages of the present disclosure will become apparent and more readily appreciated from the following descriptions made with reference to the accompanying drawings, in which:

FIG. 1 is a schematic flowchart of a method for timing adjustment according to some embodiments of the present disclosure;

FIG. 2a is a schematic flowchart of a method for timing adjustment according to some embodiments of the present disclosure;

FIG. 2b is a schematic flowchart of a method for timing adjustment according to still some embodiments of the present disclosure;

FIG. 3 is a schematic flowchart of a method for timing adjustment according to yet some embodiments of the present disclosure;

FIG. 4 is a schematic flowchart of a method for timing adjustment according to yet some embodiments of the present disclosure;

FIG. 5a is a schematic flowchart of a method for timing adjustment according to yet some embodiments of the present disclosure;

FIG. 5b is a schematic flowchart of a method for timing adjustment according to yet some embodiments of the present disclosure;

FIG. 6 is a schematic flowchart of a method for timing adjustment according to yet some embodiments of the present disclosure;

FIG. 7 is a schematic structural diagram of an apparatus for timing adjustment according to some embodiments of the present disclosure;

FIG. 8 is a schematic structural diagram of an apparatus for timing adjustment according to some embodiments of the present disclosure;

FIG. 9 is a block diagram of a user equipment according to some embodiments of the present disclosure;

FIG. 10 is a block diagram of a network side device according to some embodiments of the present disclosure.

### DETAILED DESCRIPTION

Example embodiments will be described in detail here, examples of which are illustrated in the accompanying drawings. The following description refers to the accompanying drawings in which the same numerals in different drawings represent the same or similar elements unless otherwise represented. The implementations described in the following example embodiments do not represent all implementations consistent with the embodiments of the present disclosure. By contrast, they are merely examples of apparatuses and methods consistent with some aspects of the embodiments of the present disclosure as described in detail in the appended claims.

Terms used in the embodiments of the present disclosure are merely for the purpose of describing particular embodiments, and are not intended to limit the embodiments of the present disclosure. The singular forms “a” and “the” used in the embodiments of the present disclosure and the appended claims are also intended to include plural forms, unless the context clearly indicates other meanings. It should also be understood that the term “and/or” as used here refers to and includes any or all possible combinations of one or more associated listed items.

It should be understood that although the terms “first”, “second”, “third”, or the like, may be used in the embodiments of the present disclosure to describe various information, the information should not be limited to these terms. These terms are only used to distinguish the same type of information from each other. For example, without departing from the scope of the embodiments of the present disclosure, the first information may also be referred to as second information, and similarly, the second information may also be referred to as first information. Depending on the context, the words “if” and “in case that” as used here may be interpreted as “at the time that” or “when” or “in response to determining that”.

However, the current timing adjustment rule at most supports a UE moving speed of 120 km/h. When the UE moving speed exceeds 120 km/h, it may not be able to adjust the error of the uplink transmission timing of the UE to be within the plus or minus Te in time based on the current timing adjustment rule, which may lead to communication delay or failure.

Therefore, there is an urgent need for a method for timing adjustment applicable to a UE with a high moving speed.

The method for timing adjustment, apparatus, user equipment, network side device, and non-transitory computer-readable storage medium according to the embodiments of the present disclosure are described in detail below with reference to the accompanying drawings.

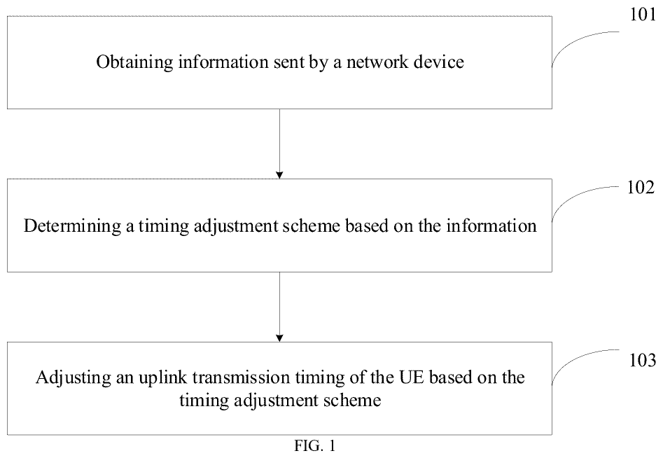

FIG. 1 is a schematic flowchart of a method for timing adjustment according to some embodiments of the present disclosure. The method is performed by a UE. As shown in FIG. 1, the method may include the following steps.

In step 101, information sent by a network device is obtained.

It should be noted that, in some embodiments of the present disclosure, the UE may refer to a device that provides voice and/or data connectivity to a user. A terminal device may communicate with one or more core networks via a Radio Access Network (RAN), and the UE may be an Internet of Things (IoT) terminal, such as a sensor device, a mobile phone (or referred to as a “cellular” phone), and a computer having an IoT terminal. For example, the UE may be a fixed, portable, pocket-sized, handheld, computer-built-in, or vehicle-mounted apparatus, such as a station (STA), a subscriber unit, a subscriber station, a mobile station, a mobile, a remote station, an access point, a remote terminal, an access terminal, a user terminal, or a user agent. Alternatively, the UE may also be a device of an unmanned aerial vehicle. Alternatively, the UE may be a vehicle-mounted device, for example, may be a trip computer having a wireless communication function, or a wireless terminal externally connected to a trip computer. Alternatively, the UE may be a roadside device, for example, may be a street lamp, a signal lamp, another roadside device, or the like, with a wireless communication function.

In some embodiments of the present disclosure, the above method may be applied to a Non-Terrestrial Networks (NTN) scenario.

In some embodiments of the present disclosure, the information may include indication information, and the indication information may be used to indicate which timing adjustment scheme the UE subsequently adopts to adjust the uplink transmission timing of the UE.

In some embodiments of the present disclosure, the information may be a speed threshold, and the UE may subsequently determine a corresponding timing adjustment scheme based on the speed threshold.

In step 102, a timing adjustment scheme is determined based on the information.

In some embodiments of the present disclosure, the timing adjustment scheme may include a maximum adjustment step size for each adjustment (such as, a timing change maximum value for each adjustment) and/or an adjustment rate (such as a minimum adjustment rate and/or a maximum adjustment rate).

In step 103, an uplink transmission timing of the UE is adjusted based on the timing adjustment scheme.

In summary, in the method for timing adjustment according to the embodiments of the present disclosure, the UE may obtain the information sent by the network device, then determine the timing adjustment scheme based on the information, and adjust the uplink transmission timing of the UE based on the timing adjustment scheme. In some embodiments of the present disclosure, the timing adjustment scheme corresponding to the UE is determined based on the UE type or the moving speed of the UE. Among them, if the UE type is a high-speed UE or the moving speed of the UE is relatively higher, the determined timing adjustment scheme is a second timing adjustment scheme with a relatively longer adjustment step size and/or a relatively greater adjustment rate; if the UE type is a low-speed UE or the moving speed of the UE is relatively lower, the determined timing adjustment scheme is a first timing adjustment scheme with a relatively shorter adjustment step size and/or a relatively smaller adjustment rate. Therefore, in the method for timing adjustment according to the embodiments of the present disclosure, the timing adjustment scheme matching the moving speed of the UE can be selected according to the moving speed of the UE, thus avoiding the problem of “the timing adjustment scheme being not applicable to the high-speed UE”, ensuring the accuracy of timing adjustment when it is for the UE with different moving speeds, and further ensuring the communication quality.

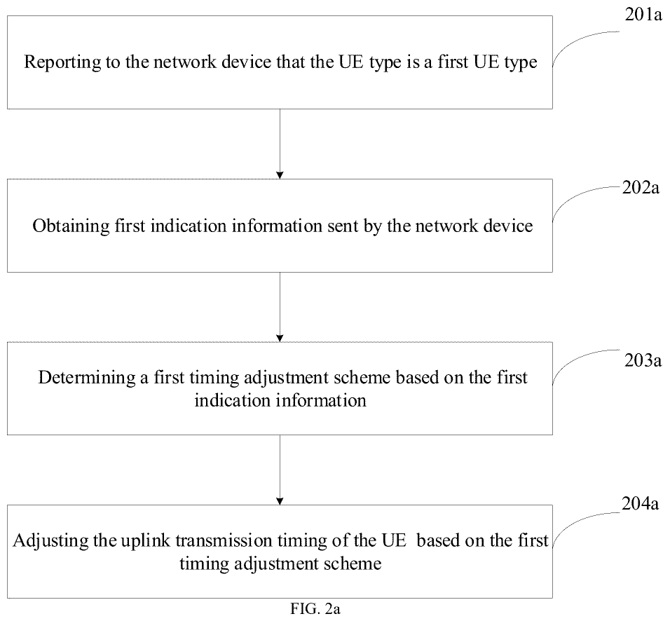

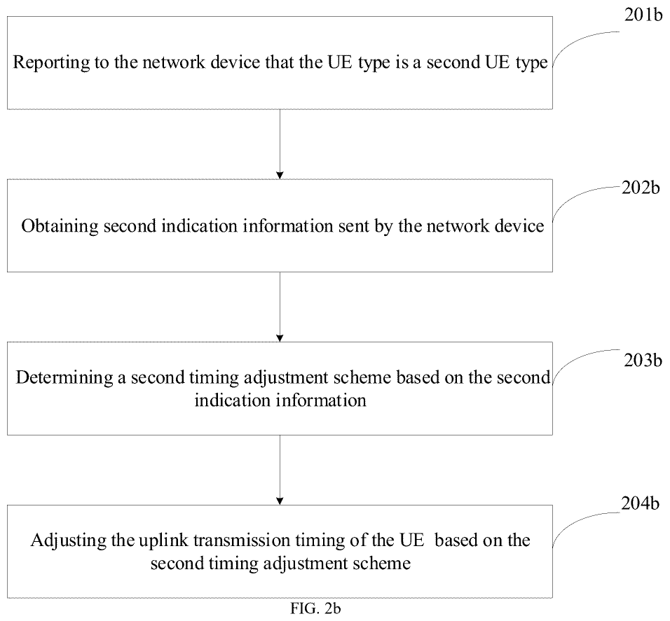

FIG. 2a is a schematic flowchart of a method for timing adjustment according to some embodiments of the present disclosure. The method is performed by a UE. As shown in FIG. 2a, the method may include the following steps.

In step 201a, it is reported to the network device that the UE type is a first UE type.

In some embodiments of the present disclosure, the UE type may mainly include a first UE type and a second UE type, where the moving speed of the UE of the first UE type is less than the moving speed of the UE of the second UE type, the UE of the first UE type is a low-speed UE (such as a UE with a moving speed less than 120 Km/H), and the UE of the second UE type is a high-speed UE (such as a UE with a moving speed of 1200 Km/H).

In some embodiments of the present disclosure, the first UE type may include at least the following types:
a handheld UE; and
a Very-Small-Aperture Terminal (VAST) UE.

And, the second UE type may include at least an Air-To-Ground (ATG) UE.

In addition, in some embodiments of the present disclosure, the UE may report the UE type to the network device through radio resource control (RRC) signaling.

In step 202a, first indication information sent by the network device is obtained. In some embodiments of the present disclosure, the first indication information may be used by for the UE to subsequently determine a specific timing adjustment scheme. In some embodiments of the present disclosure, the first indication information may be used to indicate that the UE adjusts the uplink transmission timing of the UE based on the first timing adjustment scheme. The related content about the first timing adjustment scheme will be described in detail later.

In step 203a, a first timing adjustment scheme is determined based on the first indication information.

In some embodiments of the present disclosure, the first timing adjustment scheme may be a timing adjustment scheme applicable to a low-speed UE, where the adjustment step size and/or the adjustment rate of the first timing adjustment scheme may be relatively smaller.

In some embodiments of the present disclosure, when the moving speed of the UE is relatively lower, it indicates that the position change speed of the UE is relatively lower; where, since the actual up transmission timing determined by the UE is determined by the UE based on the downlink timing information, and the downlink timing information is determined by the UE by measuring a downlink reference signal (such as a Synchronization Signal Block (SSB)), and when the position of the UE changes, the measurement results of the UE on the downlink reference signal may also change, therefore, when the position of the UE changes, the actual up transmission timing determined by the UE may change, and when the position change speed of the UE is relatively lower, the change degree of the actual up transmission timing determined by the UE may be relatively lower, so that the change degree of the error between the actual up transmission timing and the theoretical uplink transmission timing is relatively lower. Based on this, for the low-speed UE, the first timing adjustment scheme with a relatively smaller adjustment step size and/or a relatively smaller adjustment rate may be selected to fully ensure that the error of the uplink transmission timing of the UE meets the requirement (that is, the error is within the plus or minus Te).

For example, the first timing adjustment scheme may be an adjustment scheme specified in the current protocol (for example, may be a normal timing adjustment scheme specified in the current protocol). In some embodiments of the present disclosure, the first timing adjustment scheme may include at least one of the following:
1. the maximum value of the timing change for each adjustment is Tq;
2. the minimum adjustment rate is an adjustment of Tp per second;
3. the maximum adjustment rate is an adjustment of Tq per 200 ms (millisecond).

Among them, Table 1 is a situation of values of Tq and Tp according to some embodiments of the present disclosure.

TABLE 1

| | SCS of uplink | | |
|---|---|---|---|
| Frequency Range | signals (kHz) | Tq | Tp |
| 1 | 15 | 5.5 × 64 × Tc | 5.5 × 64 × Tc |
| | 30 | 5.5 × 64 × Tc | 5.5 × 64 × Tc |
| | 60 | 5.5 × 64 × Tc | 5.5 × 64 × Tc |
| 2 | 60 | 2.5 × 64 × Tc | 2.5 × 64 × Tc |
| | 120 | 2.5 × 64 × Tc | 2.5 × 64 × Tc |

Note:
Tc is the basic timing unit defined in the protocol (such as TS 38.211 [6]).

As shown in Table 1 above, when the frequency range is 1, and the SCS (Sub-Carrier Space) of the uplink signal is 15 kHz, Tq=5.5×64×Tc, and Tp=5.5×64× Tc.

In step 204a, the uplink transmission timing of the UE is adjusted based on the first timing adjustment scheme.

In some embodiments of the present disclosure, when the type of the UE is the first UE type (i.e., the low-speed UE), the uplink transmission timing of the UE may be adjusted by using the first timing adjustment scheme applicable to the low-speed UE.

For example, in some embodiments of the present disclosure, it is assumed that the first timing adjustment scheme determined in step 203a is that:
1. the maximum value of the timing change for each adjustment is 5.5×64×Tc=352 Tc;
2. the minimum adjustment rate is an adjustment of 5.5×64×Tc=352 Tc per second; and
3. the maximum adjustment rate is an adjustment of 5.5×64×Tc=352 Tc per 200 ms.

Then, the UE may adjust the uplink transmission timing of the UE directly according to the minimum adjustment rate (i.e. an adjustment of 352Tc per second), or may adjust the uplink transmission timing of the UE according to the maximum adjustment rate (i.e., an adjustment of 352Tc per 200 ms), or may adjust the uplink transmission timing of the UE according to an adjustment rate between the minimum adjustment rate and the maximum adjustment rate (e.g., an adjustment of 352Tc per 400 ms).

In summary, in the method for timing adjustment according to the embodiments of the present disclosure, the UE may obtain the information sent by the network device, then determine the timing adjustment scheme based on the information, and adjust the uplink transmission timing of the UE based on the timing adjustment scheme. In some embodiments of the present disclosure, the timing adjustment scheme corresponding to the UE is determined based on the UE type or the moving speed of the UE. Among them, if the UE type is a high-speed UE or the moving speed of the UE is relatively higher, the determined timing adjustment scheme is a second timing adjustment scheme with a relatively longer adjustment step size and/or a relatively greater adjustment rate; if the UE type is a low-speed UE or the moving speed of the UE is relatively lower, the determined timing adjustment scheme is a first timing adjustment scheme with a relatively shorter adjustment step size and/or a relatively smaller adjustment rate. Therefore, in the method for timing adjustment according to the embodiments of the present disclosure, the timing adjustment scheme matching the moving speed of the UE can be selected according to the moving speed of the UE, thus avoiding the problem of “the timing adjustment scheme being not applicable to the high-speed UE”, ensuring the accuracy of timing adjustment when it is for the UE with different moving speeds, and further ensuring the communication quality.

FIG. 2b is a schematic flowchart of a method for timing adjustment according to some embodiments of the present disclosure. The method is performed by a UE. As shown in FIG. 2b, the method may include the following steps.

In step 201b, it is reported to the network device that the UE type a second UE type.

In some embodiments of the present disclosure, the second UE type may be a high-speed UE, and the second UE type may be an ATG UE, where, for the related descriptions of the second UE type, reference may be made to the description of the foregoing embodiments, and details are not described here in the embodiments of the present disclosure.

In step 202b, second indication information sent by the network device is obtained.

In some embodiments of the present disclosure, the second indication information may be used for the UE to subsequently determine a specific timing adjustment scheme. In some embodiments of the present disclosure, the second indication information may be used to indicate that the UE adjusts the uplink transmission timing of the UE based on a second timing adjustment scheme, where the related content of the second timing adjustment scheme will be described in detail later.

In step 203b, a second timing adjustment scheme is determined based on the second indication information.

In some embodiments of the present disclosure, the second timing adjustment scheme may be a timing adjustment scheme applicable to the high-speed UE, where the second timing adjustment scheme may be an enhanced timing adjustment scheme with a relatively larger adjustment step size and/or a relatively greater adjustment rate.

In some embodiments of the present disclosure, when the moving speed of the UE is relatively higher, it indicates that the position change speed of the UE is relatively higher; where, since the actual up transmission timing determined by the UE is determined by the UE based on the downlink timing information, and the downlink timing information is determined by the UE by measuring a downlink reference signal (such as an SSB), and when the position of the UE changes, the measurement results of the UE on the downlink reference signal may also change, therefore, when the position of the UE changes, the actual up transmission timing determined by the UE may change, and when the position change speed of the UE is relatively higher, the change degree of the actual up transmission timing determined by the UE may be relatively higher, so that the change degree of the error between the actual up transmission timing and the theoretical up transmission timing is relatively higher. Based on this, for the high-speed UE, it is needed to select a second timing adjustment scheme with a relatively larger adjustment step size and/or a relatively greater adjustment rate to ensure that the error of the uplink transmission timing of the UE meets the requirement (that is, the error is within the plus or minus Te).

In some embodiments of the present disclosure, the difference between the first timing adjustment scheme and the second timing adjustment scheme may include at least one of the following:
the adjustment step size of the second timing adjustment scheme being greater than the adjustment step size of the first timing adjustment scheme;
the minimum adjustment rate of the second timing adjustment scheme being greater than the minimum adjustment rate of the first timing adjustment scheme;
the maximum adjustment rate of the second timing adjustment scheme being greater than the maximum adjustment rate of the first timing adjustment scheme; or
the minimum adjustment rate of the second timing adjustment scheme being greater than the maximum adjustment rate of the first timing adjustment scheme.

Furthermore, in some embodiments of the present disclosure, the specific content of the second timing adjustment scheme may be predefined through a protocol.

For example, in some embodiments of the present disclosure, the second timing adjustment scheme may include at least one of the following:
a. the maximum value of the timing change for each adjustment being x1 (x1>Tq);
b. the minimum adjustment rate being an adjustment of y1 per T1 second (T1<1, y1>Tp, or T1<0.2, y1>Tq);
c. the maximum adjustment rate being an adjustment of z1 per T2 second (T2<0.2, z1>Tq).

In step 204b, the uplink transmission timing of the UE is adjusted based on the second timing adjustment scheme.

In some embodiments of the present disclosure, when the type of the UE is the second UE type (i.e., the high-speed UE), the uplink transmission timing of the UE may be adjusted by using a second timing adjustment scheme applicable to the high-speed UE.

For example, in some embodiments of the present disclosure, it is assumed that the second timing adjustment scheme determined in step 203b is that:
a. the maximum value of the timing change for each adjustment is 500 Tc;
b. the minimum adjustment rate is an adjustment of 500 Tc per 100 ms; and
c. the maximum adjustment rate is an adjustment of 500 Tc per 50 ms.

Then, the UE may adjust the uplink transmission timing of the UE directly according to the minimum adjustment rate (i.e., an adjustment of 500 Tc per 100 ms), or may adjust the uplink transmission timing of the UE according to the maximum adjustment rate (i.e., an adjustment of 500 Tc per 50 ms), or may adjust the uplink transmission timing of the UE according to an adjustment rate between the minimum adjustment rate and the maximum adjustment rate (e.g., an adjustment of 352 Tc per 75 ms).

In summary, in the method for timing adjustment according to the embodiments of the present disclosure, the UE may obtain the information sent by the network device, then determine the timing adjustment scheme based on the information, and adjust the uplink transmission timing of the UE based on the timing adjustment scheme. In some embodiments of the present disclosure, the timing adjustment scheme corresponding to the UE is determined based on the UE type or the moving speed of the UE. Among them, if the UE type is a high-speed UE or the moving speed of the UE is relatively higher, the determined timing adjustment scheme is a second timing adjustment scheme with a relatively longer adjustment step size and/or a relatively greater adjustment rate; if the UE type is a low-speed UE or the moving speed of the UE is relatively lower, the determined timing adjustment scheme is a first timing adjustment scheme with a relatively shorter adjustment step size and/or a relatively smaller adjustment rate. Therefore, in the method for timing adjustment according to the embodiments of the present disclosure, the timing adjustment scheme matching the moving speed of the UE can be selected according to the moving speed of the UE, thus avoiding the problem of “the timing adjustment scheme being not applicable to the high-speed UE”, ensuring the accuracy of timing adjustment when it is for the UE with different moving speeds, and further ensuring the communication quality.

FIG. 3 is a schematic flowchart of a method for timing adjustment according to some embodiments of the present disclosure. The method is performed by a UE. As shown in FIG. 3, the method may include the following steps.

In step 301, a speed threshold sent by a network device is obtained.

Among the, in some embodiments of the present disclosure, the method for the UE to obtain the speed threshold sent by the network device may include the following.

When the UE is in a non-connected state, a speed threshold sent by the network device through a system information block (SIB) message is obtained.

When the UE is in a connected state, a speed threshold sent by the network device through RRC signaling is obtained.

In step 302, a timing adjustment scheme is determined based on the speed threshold.

In some embodiments of the present disclosure, the method for determining the timing adjustment scheme based on the speed threshold may include the following.

The size relationship between the moving speed of the UE and the speed threshold is determined; where, when the moving speed of the UE is lower than the speed threshold, it indicates that the current moving speed of the UE is relatively lower, so that the timing adjustment scheme may be determined as the first timing adjustment scheme applicable to the low-speed UE; when the moving speed of the UE is greater than or equal to the speed threshold, it indicates that the current moving speed of the UE is relatively higher, so that the timing adjustment scheme can be determined as the second timing adjustment scheme applicable to the high-speed UE.

In some embodiments, the difference between the first timing adjustment scheme and the second timing adjustment scheme includes at least one of the following:
the adjustment step size of the second timing adjustment scheme being greater than the adjustment step size of the first timing adjustment scheme;
the minimum adjustment rate of the second timing adjustment scheme being greater than the minimum adjustment rate of the first timing adjustment scheme;
the maximum adjustment rate of the second timing adjustment scheme being greater than the maximum adjustment rate of the first timing adjustment scheme; or
the minimum adjustment rate of the second timing adjustment scheme being greater than the maximum adjustment rate of the first timing adjustment scheme.

In addition, for the related descriptions about the first timing adjustment scheme and the second timing adjustment scheme, reference may be made to the description of the foregoing embodiments, and details are not described here again in the embodiments of the present disclosure.

In step 303, the uplink transmission timing of the UE is adjusted based on the timing adjustment scheme.

In summary, in the method for timing adjustment according to the embodiments of the present disclosure, the UE may obtain the information sent by the network device, then determine the timing adjustment scheme based on the information, and adjust the uplink transmission timing of the UE based on the timing adjustment scheme. In some embodiments of the present disclosure, the timing adjustment scheme corresponding to the UE is determined based on the UE type or the moving speed of the UE. In some embodiments, if the UE type is a high-speed UE or the moving speed of the UE is relatively higher, the determined timing adjustment scheme is a second timing adjustment scheme with a relatively longer adjustment step size and/or a relatively greater adjustment rate; if the UE type is a low-speed UE or the moving speed of the UE is relatively lower, the determined timing adjustment scheme is a first timing adjustment scheme with a relatively shorter adjustment step size and/or a relatively smaller adjustment rate. Therefore, in the method for timing adjustment according to the embodiments of the present disclosure, the timing adjustment scheme matching the moving speed of the UE can be selected according to the moving speed of the UE, thus avoiding the problem of “the timing adjustment scheme being not applicable to the high-speed UE”, ensuring the accuracy of timing adjustment when it is for the UE with different moving speeds, and further ensuring the communication quality.

FIG. 4 is a schematic flowchart of a method for timing adjustment according to some embodiments of the present disclosure. The method is performed by a network device. As shown in FIG. 4, the method may include the following steps.

In step 401, information is sent to a UE, where the information is used for the UE to determine a timing adjustment scheme.

In some embodiments, for other detailed descriptions of step 401, reference may be made to the description of the foregoing embodiments, and details are not described here again in the embodiments of the present disclosure.

In summary, in the method for timing adjustment according to the embodiments of the present disclosure, the UE may obtain the information sent by the network device, then determine the timing adjustment scheme based on the information, and adjust the uplink transmission timing of the UE based on the timing adjustment scheme. In some embodiments of the present disclosure, the timing adjustment scheme corresponding to the UE is determined based on the UE type or the moving speed of the UE. In some embodiments, if the UE type is a high-speed UE or the moving speed of the UE is relatively higher, the determined timing adjustment scheme is a second timing adjustment scheme with a relatively longer adjustment step size and/or a relatively greater adjustment rate; if the UE type is a low-speed UE or the moving speed of the UE is relatively lower, the determined timing adjustment scheme is a first timing adjustment scheme with a relatively shorter adjustment step size and/or a relatively smaller adjustment rate. Therefore, in the method for timing adjustment according to the embodiments of the present disclosure, the timing adjustment scheme matching the moving speed of the UE can be selected according to the moving speed of the UE, thus avoiding the problem of “the timing adjustment scheme being not applicable to the high-speed UE”, ensuring the accuracy of timing adjustment when it is for the UE with different moving speeds, and further ensuring the communication quality.

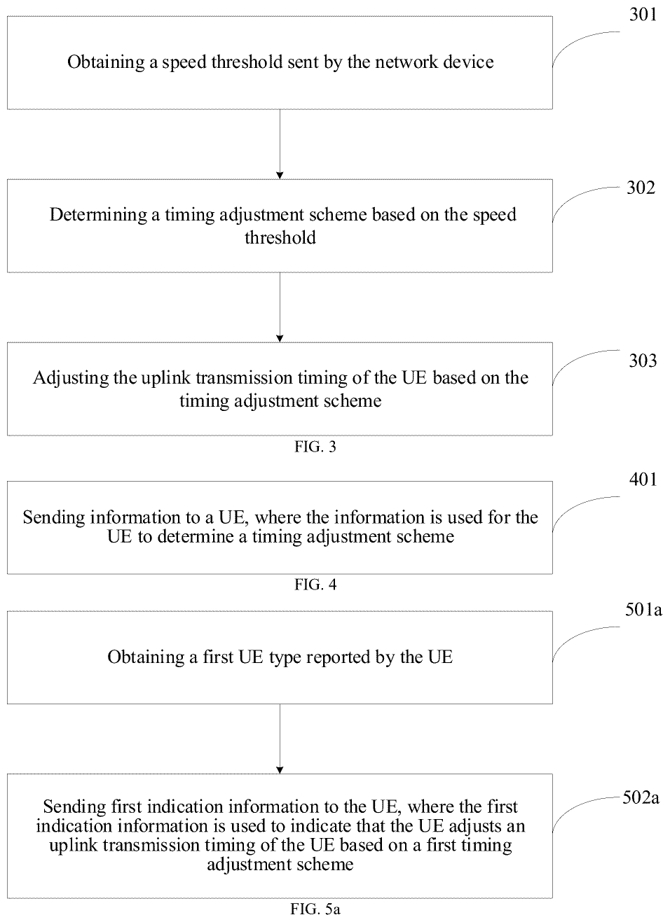

FIG. 5a is a schematic flowchart of a method for timing adjustment according to some embodiments of the present disclosure. The method is performed by a network device. As shown in FIG. 5a, the method may include the following steps.

In step 501a, a first UE type reported by a UE is obtained.

In some embodiments of the present disclosure, the UE type includes a first UE type and a second UE type. In some embodiments of the present disclosure, the moving speed of the UE of the first UE type is lower than the moving speed of the UE of the second UE type.

In step 502a, first indication information is sent to the UE, where the first indication information is used to indicate that the UE adjusts the uplink transmission timing of the UE based on a first timing adjustment scheme.

In some embodiments of the present disclosure, when the UE type is the first UE type, the first indication information is sent to the UE, so that the UE determines the first timing adjustment scheme based on the first indication information.

In some embodiments, for other detailed descriptions of steps 501a to 502a, reference may be made to the description of the foregoing embodiments, and details are not described here again in the embodiments of the present disclosure.

In summary, in the method for timing adjustment according to the embodiments of the present disclosure, the UE may obtain the information sent by the network device, then determine the timing adjustment scheme based on the information, and adjust the uplink transmission timing of the UE based on the timing adjustment scheme. In some embodiments of the present disclosure, the timing adjustment scheme corresponding to the UE is determined based on the UE type or the moving speed of the UE. In some embodiments, if the UE type is a high-speed UE or the moving speed of the UE is relatively higher, the determined timing adjustment scheme is a second timing adjustment scheme with a relatively longer adjustment step size and/or a relatively greater adjustment rate; if the UE type is a low-speed UE or the moving speed of the UE is relatively lower, the determined timing adjustment scheme is a first timing adjustment scheme with a relatively shorter adjustment step size and/or a relatively smaller adjustment rate. Therefore, in the method for timing adjustment according to the embodiments of the present disclosure, the timing adjustment scheme matching the moving speed of the UE can be selected according to the moving speed of the UE, thus avoiding the problem of “the timing adjustment scheme being not applicable to the high-speed UE”, ensuring the accuracy of timing adjustment when it is for the UE with different moving speeds, and further ensuring the communication quality.

FIG. 5b is a schematic flowchart of a method for timing adjustment according to some embodiments of the present disclosure. The method is performed by a network device. As shown in FIG. 5b, the method may include the following steps.

In step 501b, a second UE type reported by the UE is obtained.

In step 502b, second indication information is sent to the UE, where the second indication information is used to indicate that the UE adjusts the uplink transmission timing of the UE based on a second timing adjustment scheme.

In some embodiments of the present disclosure, when the UE type is the second UE type, the second indication information is sent to the UE, so that the UE determines the second timing adjustment scheme based on the second indication information.

In some embodiments, the difference between the first timing adjustment scheme and the second timing adjustment scheme includes at least one of the following:
the adjustment step size of the second timing adjustment scheme being greater than the adjustment step size of the first timing adjustment scheme;
the minimum adjustment rate of the second timing adjustment scheme being greater than the minimum adjustment rate of the first timing adjustment scheme;
the maximum adjustment rate of the second timing adjustment scheme being greater than the maximum adjustment rate of the first timing adjustment scheme; or
the minimum adjustment rate of the second timing adjustment scheme being greater than the maximum adjustment rate of the first timing adjustment scheme.

In some embodiments of the present disclosure, the specific content of the second timing adjustment scheme may be predefined through a protocol.

In some embodiments, for other detailed descriptions of steps 501b to 502b, reference may be made to the description of the foregoing embodiments, and details are not described here again in the embodiments of the present disclosure.

In summary, in the method for timing adjustment according to the embodiments of the present disclosure, the UE may obtain the information sent by the network device, then determine the timing adjustment scheme based on the information, and adjust the uplink transmission timing of the UE based on the timing adjustment scheme. In some embodiments of the present disclosure, the timing adjustment scheme corresponding to the UE is determined based on the UE type or the moving speed of the UE. In some embodiments, if the UE type is a high-speed UE or the moving speed of the UE is relatively higher, the determined timing adjustment scheme is a second timing adjustment scheme with a relatively longer adjustment step size and/or a relatively greater adjustment rate; if the UE type is a low-speed UE or the moving speed of the UE is relatively lower, the determined timing adjustment scheme is a first timing adjustment scheme with a relatively shorter adjustment step size and/or a relatively smaller adjustment rate. Therefore, in the method for timing adjustment according to the embodiments of the present disclosure, the timing adjustment scheme matching the moving speed of the UE can be selected according to the moving speed of the UE, thus avoiding the problem of “the timing adjustment scheme being not applicable to the high-speed UE”, ensuring the accuracy of timing adjustment when it is for the UE with different moving speeds, and further ensuring the communication quality.

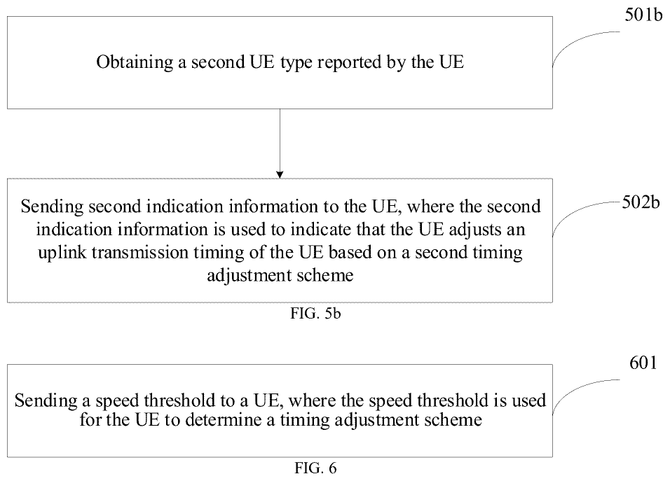

FIG. 6 is a schematic flowchart of a method for timing adjustment according to some embodiments of the present disclosure. The method is performed by a network device. As shown in FIG. 6, the method may include the following step.

In step 601, a speed threshold is sent to a UE, where the speed threshold is used for the UE to determine a timing adjustment scheme.

In some embodiments of the present disclosure, the method for the network device to send the speed threshold to the UE may include the following.

The speed threshold is sent to the UE through the SIB message.

The speed threshold is sent to the UE through RRC signaling.

In some embodiments, for other detailed descriptions of step 601, reference may be made to the description of the foregoing embodiments, and details are not described here again in the embodiments of the present disclosure.

In summary, in the method for timing adjustment according to the embodiments of the present disclosure, the UE may obtain the information sent by the network device, then determine the timing adjustment scheme based on the information, and adjust the uplink transmission timing of the UE based on the timing adjustment scheme. In some embodiments of the present disclosure, the timing adjustment scheme corresponding to the UE is determined based on the UE type or the moving speed of the UE. In some embodiments, if the UE type is a high-speed UE or the moving speed of the UE is relatively higher, the determined timing adjustment scheme is a second timing adjustment scheme with a relatively longer adjustment step size and/or a relatively greater adjustment rate; if the UE type is a low-speed UE or the moving speed of the UE is relatively lower, the determined timing adjustment scheme is a first timing adjustment scheme with a relatively shorter adjustment step size and/or a relatively smaller adjustment rate. Therefore, in the method for timing adjustment according to the embodiments of the present disclosure, the timing adjustment scheme matching the moving speed of the UE can be selected according to the moving speed of the UE, thus avoiding the problem of “the timing adjustment scheme being not applicable to the high-speed UE”, ensuring the accuracy of timing adjustment when it is for the UE with different moving speeds, and further ensuring the communication quality.

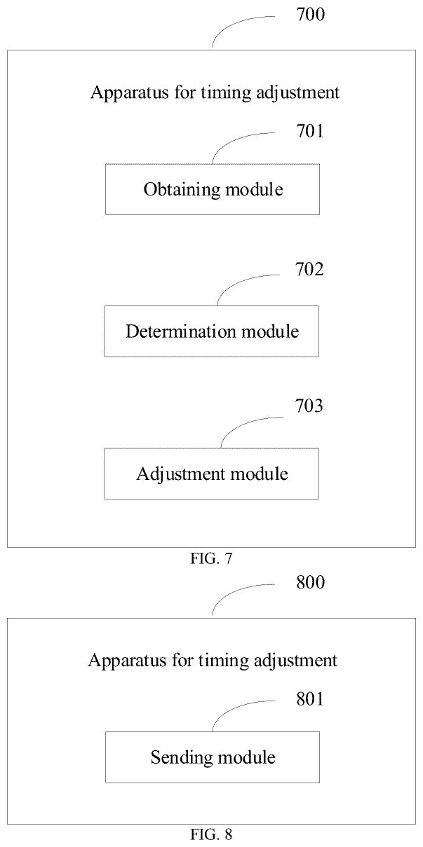

FIG. 7 is a schematic structural diagram of an apparatus 700 for timing adjustment according to some embodiments of the present disclosure. As shown in FIG. 7, the apparatus 700 may include:
an obtaining module 701, configured to obtain information sent by a network device;
a determination module 702, configured to determine a timing adjustment scheme based on the information; and
an adjustment module 703, configured to adjust an uplink transmission timing of the UE based on the timing adjustment scheme.

In summary, in the apparatus for timing adjustment according to the embodiments of the present disclosure, the UE may obtain the information sent by the network device, then determine the timing adjustment scheme based on the information, and adjust the uplink transmission timing of the UE based on the timing adjustment scheme. In some embodiments of the present disclosure, the timing adjustment scheme corresponding to the UE is determined based on the UE type or the moving speed of the UE. In some embodiments, if the UE type is a high-speed UE or the moving speed of the UE is relatively higher, the determined timing adjustment scheme is a second timing adjustment scheme with a relatively longer adjustment step size and/or a relatively greater adjustment rate; if the UE type is a low-speed UE or the moving speed of the UE is relatively lower, the determined timing adjustment scheme is a first timing adjustment scheme with a relatively shorter adjustment step size and/or a relatively smaller adjustment rate. Therefore, in the method for timing adjustment according to the embodiments of the present disclosure, the timing adjustment scheme matching the moving speed of the UE can be selected according to the moving speed of the UE, thus avoiding the problem of “the timing adjustment scheme being not applicable to the high-speed UE”, ensuring the accuracy of timing adjustment when it is for the UE with different moving speeds, and further ensuring the communication quality.

In some embodiments of the present disclosure, the apparatus is further configured to:

report a UE type of the UE to the network device, where the UE type includes a first UE type and a second UE type, and a moving speed of the UE of the first UE type is less than a moving speed of the UE of the second UE type.

In some embodiments of the present disclosure, the apparatus is further configured to:
report the UE type of the UE to the network device through radio resource control (RRC) signaling.

In some embodiments of the present disclosure, the obtaining module is further configured to:
when the UE type is the first UE type, obtain first indication information sent by the network device.

In some embodiments of the present disclosure, the determination module is further configured to:
determine, based on the first indication information, that the timing adjustment scheme is a first timing adjustment scheme.

In some embodiments of the present disclosure, the obtaining module is further configured to:
when the UE type is the second UE type, obtain second indication information sent by the network device.

In some embodiments of the present disclosure, the determination module is further configured to:
determine, based on the second indication information, that the timing adjustment scheme is a second timing adjustment scheme.

In some embodiments of the present disclosure, the difference between the first timing adjustment scheme and the second timing adjustment scheme includes at least one of the following:
an adjustment step size of the second timing adjustment scheme being greater than an adjustment step size of the first timing adjustment scheme;
a minimum adjustment rate of the second timing adjustment scheme being greater than a minimum adjustment rate of the first timing adjustment scheme;
a maximum adjustment rate of the second timing adjustment scheme being greater than a maximum adjustment rate of the first timing adjustment scheme; or
a minimum adjustment rate of the second timing adjustment scheme being greater than a maximum adjustment rate of the first timing adjustment scheme.

In some embodiments of the present disclosure, the obtaining module is further configured to:
obtain a speed threshold sent by the network device.

In some embodiments of the present disclosure, the determination module is further configured to:
determine a size relationship between a moving speed of the UE and the speed threshold;
when the moving speed of the UE is less than the speed threshold, determine that the timing adjustment scheme is a first timing adjustment scheme; and
when the moving speed of the UE is greater than or equal to the speed threshold, determine that the timing adjustment scheme is a second timing adjustment scheme;
where a difference between the first timing adjustment scheme and the second timing adjustment scheme includes at least one of the following:
an adjustment step size of the second timing adjustment scheme being greater than an adjustment step size of the first timing adjustment scheme; and
a minimum adjustment rate of the second timing adjustment scheme being greater than a minimum adjustment rate of the first timing adjustment scheme; and
a maximum adjustment rate of the second timing adjustment scheme being greater than a maximum adjustment rate of the first timing adjustment scheme; or
a minimum adjustment rate of the second timing adjustment scheme being greater than a maximum adjustment rate of the first timing adjustment scheme.

In some embodiments of the present disclosure, the obtaining module is further configured to:
when the UE is in a non-connected state, obtain the speed threshold sent by the network device through a SIB message.

In some embodiments of the present disclosure, the obtaining module is further configured to:
when the UE is in a connected state, obtain the speed threshold sent by the network device through RRC signaling.

FIG. 8 is a schematic structural diagram of an apparatus 800 for timing adjustment according to an embodiment of the present disclosure. As shown in FIG. 8, the apparatus 800 may include:
a sending module 801, configured to send information to a UE, where the information is used for the UE to determine a timing adjustment scheme.

In summary, in the apparatus for timing adjustment according to the embodiments of the present disclosure, the UE may obtain the information sent by the network device, then determine the timing adjustment scheme based on the information, and adjust the uplink transmission timing of the UE based on the timing adjustment scheme. In some embodiments of the present disclosure, the timing adjustment scheme corresponding to the UE is determined based on the UE type or the moving speed of the UE. Among them, if the UE type is a high-speed UE or the moving speed of the UE is relatively higher, the determined timing adjustment scheme is a second timing adjustment scheme with a relatively longer adjustment step size and/or a relatively greater adjustment rate; if the UE type is a low-speed UE or the moving speed of the UE is relatively lower, the determined timing adjustment scheme is a first timing adjustment scheme with a relatively shorter adjustment step size and/or a relatively smaller adjustment rate. Therefore, in the method for timing adjustment according to the embodiments of the present disclosure, the timing adjustment scheme matching the moving speed of the UE can be selected according to the moving speed of the UE, thus avoiding the problem of “the timing adjustment scheme being not applicable to the UE with a high moving speed”, ensuring the accuracy of timing adjustment when it is for the UE with different moving speeds, and further ensuring the communication quality.

In some embodiments of the present disclosure, the apparatus is further configured to:
obtain a UE type reported by the UE, where the UE type includes a first UE type and a second UE type, and a moving speed of the UE of the first UE type is less than a moving speed of the UE of the second UE type.

In some embodiments of the present disclosure, the apparatus is further configured to:
obtain the UE type reported by the UE through RRC signaling.

In some embodiments of the present disclosure, the sending module is further configured to:
when the UE type is the first UE type, send first indication information to the UE, where the first indication information is used to indicate that the UE adjusts an uplink transmission timing of the UE based on a first timing adjustment scheme, and the first timing adjustment scheme matches the moving speed of the first UE type.

In some embodiments of the present disclosure, the sending module is further configured to:
when the UE type is the second UE type, send second indication information to the UE, where the second indication information is used to indicate that the UE adjusts an uplink transmission timing of the UE based on a second timing adjustment scheme, and the second timing adjustment scheme matches the moving speed of the second UE type.

In some embodiments of the present disclosure, the difference between the first timing adjustment scheme and the second timing adjustment scheme includes at least one of the following:
an adjustment step size of the second timing adjustment scheme being greater than an adjustment step size of the first timing adjustment scheme;
a minimum adjustment rate of the second timing adjustment scheme being greater than a minimum adjustment rate of the first timing adjustment scheme;
a maximum adjustment rate of the second timing adjustment scheme being greater than a maximum adjustment rate of the first timing adjustment scheme; or
a minimum adjustment rate of the second timing adjustment scheme being greater than a maximum adjustment rate of the first timing adjustment scheme.

In some embodiments of the present disclosure, the sending module is further configured to:
send a speed threshold to the UE.

In some embodiments of the present disclosure, the sending module is further configured to:
send the speed threshold to the UE through a SIB message.

In some embodiments of the present disclosure, the sending module is further configured to:
send the speed threshold to the UE through RRC signaling.

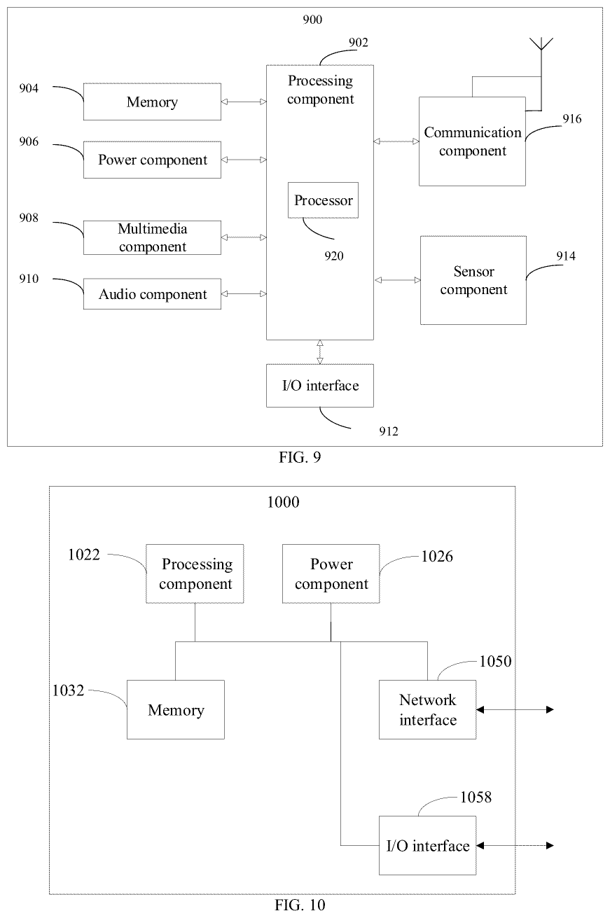

FIG. 9 is a block diagram of a user equipment UE 900 according to an embodiment of the present disclosure. For example, the UE 900 may be a mobile phone, a computer, a digital broadcast terminal device, a message transceiving device, a game console, a tablet device, a medical device, a fitness device, a personal digital assistant, or the like.

Referring to FIG. 9, the UE 900 may include at least one of the following components: a processing component 902, a memory 904, a power component 906, a multimedia component 908, an audio component 910, an input/output (I/O) interface 912, a sensor component 913, and a communication component 916.

The processing component 902 typically controls overall operations of the UE 900, such as display, telephone calls, data communications, camera operations, and operations associated with recording operations. The processing component 902 may include at least one processor 920 to execute instructions to perform all or part of the steps in the foregoing methods. Moreover, the processing component 902 may include at least one module that facilitates interaction between the processing component 902 and other components. For example, the processing component 902 may include a multimedia module to facilitate interaction between the multimedia component 908 and the processing component 902.

The memory 904 is configured to store various types of data to support the operations on the UE 900. Examples of such data include instructions, contact data, phonebook data, messages, pictures, videos, or the like, for any application or method operating on the UE 900. The memory 904 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 906 provides power to various components of the UE 900. The power component 906 may include a power management system, at least one power source, and other components associated with generating, managing, and distributing power for the UE 900.

The multimedia component 908 includes a screen providing an output interface between the UE 900 and the user. In some embodiments, the screen may include a liquid crystal display (LCD) and a touch panel (TP). If the screen includes the touch panel, the screen may be implemented as a touch screen to receive input signals from the user. The touch panel includes at least one touch sensor to sense touching, sliding, and gestures on the touch panel. The touch sensor may not only sense a boundary of a touching or sliding action, but also detect a wake-up time and a pressure associated with the touching or sliding action. In some embodiments, the multimedia component 908 includes a front camera and/or a rear camera. When the UE 900 is in an operation mode, such as a photographing mode or a video mode, the front camera and/or the rear camera may receive external multimedia data. Each of the front camera and the rear camera may be a fixed optical lens system or have a focal length and optical zoom capability.

The audio component 910 is configured to output and/or input audio signals. For example, the audio component 910 includes a microphone (MIC) configured to receive an external audio signal when the UE 900 is in an operation mode, such as a call mode, a recording mode, and a voice recognition mode. The received audio signal may be further stored in the memory 904 or transmitted via the communication component 916. In some embodiments, the audio component 910 further includes a speaker for outputting audio signals.

The I/O interface 912 provides an interface between the processing component 902 and a peripheral interface module, and the peripheral interface module may be a keyboard, a click wheel, a button, or the like. The button may include, but is not limited to, a home button, a volume button, a starting button, and a locking button.

The sensor component 913 includes at least one sensor for providing status assessments of various aspects of the UE 900. For example, the sensor component 913 may detect an on/off state of the device 900, relative positioning of the components, for example, the components is a display and a keypad of the UE 900; the sensor component 913 may also detect a position change of the UE 900 or one component of the UE 900, the presence or absence of contact by the user with the UE 900, the orientation or acceleration/deceleration of the UE 900, and the temperature change of the UE 900. The sensor component 913 may include a proximity sensor configured to detect the presence of nearby objects without any physical contact. The sensor component 913 may also include an optical sensor, such as a CMOS or CCD image sensor, for use in imaging applications. In some embodiments, the sensor component 913 may further include an acceleration sensor, a gyroscope sensor, a magnetic sensor, a pressure sensor, or a temperature sensor.

The communication component 916 is configured to facilitate wired or wireless communication between the UE 900 and other devices. The UE 900 may access a wireless network based on a communication standard, such as WiFi, 2G, or 3G, or a combination of them. In an example embodiment, the communication component 916 receives a broadcast signal or broadcast related information from an external broadcast management system via a broadcast channel. In an example embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an example embodiment, the UE 900 may be implemented by at least one application specific integrated circuit (ASIC), a digital signal processor (DSP), a digital signal processing device (DSPD), a programmable logic device (PLD), a field programmable gate array (FPGA), a controller, a microcontroller, a microprocessor, or other electronic components for performing the methods described above.

FIG. 10 is a block diagram of a network side device 1000 according to an embodiment of the present disclosure. For example, the network side device 1000 may be provided as a network side device. Referring to FIG. 10, the network side device 1000 includes a processing component 1022, which further includes at least one processor and memory resources represented by the memory 1032 and configured to store instructions, such as an application, executable by the processing component 1022. The application program stored in the memory 1032 may include one or more modules each of which corresponds to a set of instructions. In addition, the processing component 1010 is configured to execute the instructions to perform any of the foregoing methods applied to the network side device, such as the method as shown in FIG. 4.

The network side device 1000 may further include a power component 1026 configured to perform power management of the network side device 1000, a wired or wireless network interface 1050 configured to connect the network side device 1000 to the network, and an input/output (I/O) interface 1058. The network side device 1000 may be operable based on an operating system stored in the memory 1032, such as Windows Server™, Mac OS X™, Unix™, Linux™, Free BSD™, or the like.

In the foregoing embodiments provided in the present disclosure, the methods provided in the embodiments of the present disclosure are separately described from the perspective of the network side device and the UE. To implement the functions in the methods provided in the foregoing embodiments of the present disclosure, the network side device and the UE may include a hardware structure and a software module, to implement the foregoing functions in a form of a hardware structure, a software module, or a hardware structure plus software module. A function in the foregoing functions may be performed by using a hardware structure, a software module, or a hardware structure plus a software module.

According to embodiments of the present disclosure, there is provided a communication apparatus. The communication apparatus may include a transceiver module and a processing module. The transceiver module may include a transmission module and/or a receiving module, the transmission module is configured to implement a transmission function, the receiving module is configured to implement a receiving function, and the transceiver module may implement a transmission function and/or a receiving function.

The communication apparatus may be a terminal device (for example, the terminal device in the foregoing method embodiments), may be an apparatus in the terminal device, or may be an apparatus that can be used by matching with the terminal device. Alternatively, the communication apparatus may be a network device, may be an apparatus in the network device, or may be an apparatus that can be used by matching with the network device.

According to embodiments of the present disclosure, there is provided another communication apparatus. The communication apparatus may be a network device, or may be a terminal device (for example, a terminal device in the foregoing method embodiments), or may be a chip, a chip system, a processor that supports the network device to implement the foregoing methods, or may be a chip, a chip system, a processor that supports the terminal device to implement the foregoing methods. The apparatus may be configured to implement the method described in the foregoing method embodiments, and the details may refer to the descriptions in the foregoing method embodiments.

The communication apparatus may include one or more processors. The processor may be a general-purpose processor, a dedicated processor, or the like. For example, the processor may be a baseband processor or a central processing unit. The baseband processor may be configured to process a communication protocol and communication data, and the central processing unit may be configured to control the communication apparatus (for example, a network side device, a baseband chip, a terminal device, a terminal device chip, a DU, or a CU), execute a computer program, and process data of the computer program.

In some embodiments, the communication apparatus may further include one or more memories, where computer programs may be stored on the memories, and the processor executes the computer programs, so that the communication apparatus performs the method described in the foregoing method embodiments. In some embodiments, the memory may further store data. The communication apparatus and the memory may be separately disposed, or may be integrated together.

In some embodiments, the communication apparatus may further include a transceiver and an antenna. The transceiver may be referred to as a transceiving unit, a transceiving machine, a transceiving circuit, or the like, and is configured to implement a transceiving function. The transceiver may include a receiver and a transmitter; the receiver may be referred to as a receiving machine or a receiving circuit, and is configured to implement a receiving function; and the transmitter may be referred to as a transmission machine or a transmission circuit, and is configured to implement a transmission function.

In some embodiments, the communication apparatus may further include one or more interface circuits. The interface circuit is configured to receive a code instruction and transmit the code instruction to the processor. The processor runs the code instruction to enable the communication apparatus to perform the method described in the foregoing method embodiments.

The communication apparatus is a terminal device (for example, the terminal device in the foregoing method embodiments), and the processor is configured to perform the method shown in any one of FIG. 1 to FIG. 4.

The communication apparatus is a network device, and the transceiver is configured to perform the method shown in any one of FIG. 5 to FIG. 7.

In an embodiment, the processor may include a transceiver configured to implement a receiving and transmission function. For example, the transceiver may be a transceiving circuit, an interface, or an interface circuit. The transceiving circuit, the interface, or the interface circuit configured to implement the receiving and transmission functions may be separate, or may be integrated together. The above transceiving circuit, the interface, or the interface circuit may be configured for reading/writing of the code/data; or, the above transceiving circuit, the interface, or the interface circuit may be configured for transmission or delivery of a signal.

In an embodiment, the processor may store a computer program, and the computer program runs on the processor to enable the communication apparatus to perform the method described in the foregoing method embodiments. The computer program may be cured in a processor, in which case the processor may be implemented by hardware.

In an embodiment, the communication apparatus may include a circuit, and the circuit may implement a function of transmission or receiving or communication in the foregoing method embodiments. The processor and the transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, or the like. The processor and the transceiver may also be fabricated by using various IC process technologies, such as complementary metal oxide semiconductor (CMOS), nMetal oxide-semiconductor (NMOS), positive channel metal oxide semiconductor (PMOS), bipolar junction transistor (BJT), bipolar CMOS (BiCMOS), Silicon Germanium (SiGe), Gallium Arsenide (GaAs), etc.

The communication apparatus in the foregoing embodiments may be a network device or a terminal device (for example, the terminal device in the foregoing method embodiments), but the scope of the communication apparatus described in the present disclosure is not limited to them, and the structure of the communication apparatus may not be limited. The communication apparatus may be an independent device or may be part of a larger device. For example, the communication apparatus may be:
(1) an independent integrated circuit IC, or a chip, or a chip system or subsystem;
(2) a set having one or more ICs, in some embodiments, the IC set may also include a storage component for storing data and a computer program;
(3) an ASIC, such as a modem;
(4) a module that can be embedded in other devices;
(5) a receiver, a terminal device, a smart terminal device, a cellular phone, a wireless device, a handset, a mobile unit, a vehicle-mounted device, a network device, a cloud device, an artificial intelligence device, etc.
(6) other devices or the like.

For the case that the communication apparatus may be a chip or a chip system, the chip includes a processor and an interface. Among them, there may be one or more processors, and there may be a plurality of interfaces.

In some embodiments, the chip further includes a memory, and the memory is configured to store necessary computer programs and data.

Those skilled in the art may further understand that various illustrative logical blocks and steps listed in the embodiments of the present disclosure may be implemented by electronic hardware, computer software, or a combination of them. Whether such function is implemented by hardware or software depends on the particular applications and design requirements of the overall system. Those skilled in the art may use various methods to implement the functions for each particular application, but it should not be understood that the implementation goes beyond the protection scope of the embodiments of the present disclosure.

According to an embodiment of the present disclosure, there is further provided a system for timing adjustment, where the system includes a communication apparatus that serves as a terminal device (for example, the UE in the foregoing method embodiments) and a communication apparatus that serves as a network device in the foregoing embodiments.

According to the present disclosure, there is further provided a non-transitory computer-readable storage medium stored an instruction that, when executed by a computer, implements the functions of any one of the above method embodiments.

According to the present disclosure, there is further provided a computer program product. When the computer program product is executed by a computer, the functions of any one of the above method embodiments are implemented.

The present disclosure provides a method for timing adjustment/apparatus/device and a non-transitory computer-readable storage medium, to provide a method for timing adjustment applicable to a UE with a high moving speed.

According to embodiments of a first aspect of the present disclosure, there is provided a method, performed by a UE, and including:
obtaining information sent by a network device;
determining a timing adjustment scheme based on the information; and
adjusting an uplink transmission timing of the UE based on the timing adjustment scheme.

According to embodiments of a second aspect of the present disclosure, there is provided a method, performed by a network device, and including:
sending information to a UE, where the information is used for the UE to determine a timing adjustment scheme.

According to embodiments of another aspect of the present disclosure, there is provided a communication apparatus, including:
an obtaining module, configured to obtain information sent by a network device;
a determination module, configured to determine a timing adjustment scheme based on the information; and
an adjustment module, configured to adjust an uplink transmission timing of the UE based on the timing adjustment scheme.

According to embodiments of still another aspect of the present disclosure, there is provided a communication apparatus, including:
a sending module, configured to send information to a UE, where the information is used for the UE to determine a timing adjustment scheme.

According to embodiments of still another aspect of the present disclosure, there is provided a communication apparatus, where the apparatus includes a processor and a memory, the memory stores a computer program, and the processor executes the computer program stored in the memory to enable the apparatus to perform the method according to the embodiments of the first aspect.

According to embodiments of still another aspect of the present disclosure, there is provided a communication apparatus, where the apparatus includes a processor and a memory, the memory stores a computer program, and the processor executes the computer program stored in the memory to enable the apparatus to perform the method according to the embodiments of the second aspect.

According to embodiments of still another aspect of the present disclosure, there is provided a communication apparatus, including:
a processor and an interface circuit;
the interface circuit is configured to receive a code instruction and transmit the code instruction to the processor; and
the processor is configured to run the code instruction to perform the method according to the embodiments of the first aspect.

According to embodiments of still another aspect of the present disclosure, there is provided a communication apparatus, including:
a processor and an interface circuit;
the interface circuit is configured to receive a code instruction and transmit the code instruction to the processor; and
the processor is configured to run the code instruction to perform the method according to the embodiments of the second aspect.

According to embodiments of still another aspect of the present disclosure, there is provided a non-transitory computer-readable storage medium, configured to store an instruction, and when the instruction is executed, the method provided to the embodiments of the first of the present disclosure is implemented.

According to embodiments of still another aspect of the present disclosure, there is provided a non-transitory computer-readable storage medium, configured to store an instruction, and when the instruction is executed, the method provided to the embodiments of the second aspect of the present disclosure is implemented.

In summary, in the method for timing adjustment/apparatus/device and the non-transitory computer-readable storage medium according to the embodiments of the present disclosure, the UE may obtain the information sent by the network device, then determine the timing adjustment scheme based on the information, and adjust the uplink transmission timing of the UE based on the timing adjustment scheme. In some embodiments of the present disclosure, the timing adjustment scheme corresponding to the UE is determined based on the UE type or the moving speed of the UE. Among them, if the UE type is a high-speed UE or the moving speed of the UE is relatively higher, the determined timing adjustment scheme is a second timing adjustment scheme with a relatively longer adjustment step size and/or a relatively greater adjustment rate; if the UE type is a low-speed UE or the moving speed of the UE is relatively lower, the determined timing adjustment scheme is a first timing adjustment scheme with a relatively shorter adjustment step size and/or a relatively smaller adjustment rate. Therefore, in the method for timing adjustment according to the embodiments of the present disclosure, the timing adjustment scheme matching the moving speed of the UE can be selected according to the moving speed of the UE, thus avoiding the problem of “the timing adjustment scheme being not applicable to the UE with a high moving speed”, ensuring the accuracy of timing adjustment when it is for the UE with different moving speeds, and further ensuring the communication quality.

All or some of the foregoing embodiments may be implemented by using software, hardware, firmware, or any combination of them. When implemented by using software, all or some of the embodiments may be implemented in a form of a computer program product. The computer program product includes one or more computer programs. When the computer program is loaded and executed on a computer, the procedures or functions according to the embodiments of the present disclosure are all or partially generated. The computer may be a general-purpose computer, a dedicated computer, a computer network, or another programmable apparatus. The computer program may be stored in a computer-readable storage medium or transmitted from one computer-readable storage medium to another computer-readable storage medium; for example, the computer program may be transmitted from a website, computer, server, or data center to another website, computer, server, or data center in a wired manner (for example, a coaxial cable, an optical fiber, a digital subscriber line (DSL)) or a wireless manner (for example, infrared, wireless, microwave, or the like). The computer-readable storage medium may be any usable medium accessible by a computer, or a data storage device, such as a server or a data center including one or more usable medium integration. The usable medium may be a magnetic medium (for example, a floppy disk, a hard disk, or a magnetic tape), an optical medium (for example, a high-density digital video disk (DVD)), a semiconductor medium (for example, a solid state disk (SSD)), or the like.

Those of ordinary skill in the art may understand that various numerical numbers, such as first and second, involved in the present disclosure are merely used to distinguish for ease of description, and are not intended to limit the scope of the embodiments of the present disclosure, and also represent a sequential order.

“At least one” in the present disclosure may also be described as one or more, and more than one may be two, three, four, or more, which is not limited in the present disclosure. In the embodiments of the present disclosure, for a kind of technical features, technical features in the kind of technical features are distinguished by “first”, “second”, “third”, “A”, “B”, “C” and “D”, etc. The technical features described by “first”, “second”, “third”, “A”, “B”, “C” and “D” do not have a sequential order or a size order.

Other embodiments of the present disclosure will be apparent to those skilled in the art from consideration of the description and practice of the present disclosure. The present disclosure is intended to cover any variations, uses, or adaptations of the present disclosure following the general principles of the present disclosure and including the common general knowledge and conventional technical means in the art not disclosed in the present disclosure. It is intended that the description and examples are considered as examples only, with a true scope and spirit of the present disclosure being indicated by the following claims.

It should be understood that the present disclosure is not limited to the precise structures that have been described above and shown in the accompanying drawings, and various modifications and changes may be made without departing from the scope of the present disclosure. It is intended that the scope of the present disclosure is only limited by the appended claims.

1. A method for timing adjustment, performed by a user equipment (UE), comprising:
obtaining information sent by a network device;
determining a timing adjustment scheme based on the information; and
adjusting an uplink transmission timing of the UE based on the timing adjustment scheme.

2. The method according to claim 1, further comprising:
reporting a UE type of the UE to the network device through radio resource control (RRC) signaling, wherein the UE type comprises a first UE type and a second UE type, and a moving speed of a UE of the first UE type is less than a moving speed of a UE of the second UE type.

3. (canceled)

4. The method according to claim 2, wherein obtaining the information sent by the network device comprises:
when the UE type is the first UE type, obtaining first indication information sent by the network device, wherein the first indication information is used to indicate that the UE adjusts the uplink transmission timing of the UE based on a first timing adjustment scheme, and the first timing adjustment scheme matches the moving speed of the UE of the first UE type.

5. The method according to claim 4, wherein determining the timing adjustment scheme based on the information comprises:
determining, based on the first indication information, that the timing adjustment scheme is the first timing adjustment scheme.

6. The method according to claim 2, wherein obtaining the information sent by the network device comprises:
when the UE type is the second UE type, obtaining second indication information sent by the network device, wherein the second indication information is used to indicate that the UE adjusts the uplink transmission timing of the UE based on a second timing adjustment scheme, and the second timing adjustment scheme matches the moving speed of the UE of the second UE type.

7. The method according to claim 6, wherein determining the timing adjustment scheme based on the information comprises:
determining, based on the second indication information, that the timing adjustment scheme is the second timing adjustment scheme.

8. The method according to claim 4, wherein a difference between the first timing adjustment scheme and the second timing adjustment scheme comprises at least one of:
an adjustment step size of the second timing adjustment scheme being greater than an adjustment step size of the first timing adjustment scheme;
a minimum adjustment rate of the second timing adjustment scheme being greater than a minimum adjustment rate of the first timing adjustment scheme;
a maximum adjustment rate of the second timing adjustment scheme being greater than a maximum adjustment rate of the first timing adjustment scheme; or
a minimum adjustment rate of the second timing adjustment scheme being greater than a maximum adjustment rate of the first timing adjustment scheme.

9. The method according to claim 1, wherein obtaining the information sent by the network device comprises:
obtaining a speed threshold sent by the network device.

10. The method according to claim 9, wherein determining the timing adjustment scheme based on the information comprises:
determining a size relationship between a moving speed of the UE and the speed threshold;
in response to the moving speed of the UE being less than the speed threshold, determining that the timing adjustment scheme is a first timing adjustment scheme; and
in response to the moving speed of the UE being greater than or equal to the speed threshold, determining that the timing adjustment scheme is a second timing adjustment scheme;
wherein a difference between the first timing adjustment scheme and the second timing adjustment scheme comprises at least one of:
an adjustment step size of the second timing adjustment scheme being greater than an adjustment step size of the first timing adjustment scheme;
a minimum adjustment rate of the second timing adjustment scheme being greater than a minimum adjustment rate of the first timing adjustment scheme;
a maximum adjustment rate of the second timing adjustment scheme being greater than a maximum adjustment rate of the first timing adjustment scheme; or
a minimum adjustment rate of the second timing adjustment scheme being greater than a maximum adjustment rate of the first timing adjustment scheme.

11. The method according to claim 9, wherein obtaining the speed threshold sent by the network device comprises at least one of:
in response to the UE being in a non-connected state, obtaining the speed threshold sent by the network device through a system information block (SIB) message; or
in response to the UE being in a connected state, obtaining the speed threshold sent by the network device through radio resource control (RRC) signaling.

12. (canceled)

13. A method for timing adjustment, performed by a network device, and comprising:
sending information to a UE, wherein the information is used for the UE to determine a timing adjustment scheme.

14. The method according to claim 13, further comprising:
obtaining a UE type reported by the UE, wherein the UE type comprises a first UE type and a second UE type, and a moving speed of a UE of the first UE type is less than a moving speed of a UE of the second UE type.

15. The method according to claim 14, wherein obtaining the UE type reported by the UE comprises:
obtaining the UE type reported by the UE through RRC signaling.

16. The method according to claim 14, wherein sending the information to the UE comprises at least one of:
in response to the UE type being the first UE type, sending first indication information to the UE, wherein the first indication information is used to indicate that the UE adjusts an uplink transmission timing of the UE based on a first timing adjustment scheme, and the first timing adjustment scheme matches the moving speed of the UE of the first UE type; or
in response to the UE type being the second UE type, sending second indication information to the UE, wherein the second indication information is used to indicate that the UE adjusts an uplink transmission timing of the UE based on a second timing adjustment scheme, and the second timing adjustment scheme matches the moving speed of the UE of the second UE type.

17. (canceled)

18. The method according to claim 16 or 17, wherein a difference between the first timing adjustment scheme and the second timing adjustment scheme comprises at least one of:
an adjustment step size of the second timing adjustment scheme being greater than an adjustment step size of the first timing adjustment scheme;
a minimum adjustment rate of the second timing adjustment scheme being greater than a minimum adjustment rate of the first timing adjustment scheme;
a maximum adjustment rate of the second timing adjustment scheme being greater than a maximum adjustment rate of the first timing adjustment scheme; or
a minimum adjustment rate of the second timing adjustment scheme being greater than a maximum adjustment rate of the first timing adjustment scheme.

19. The method according to claim 13, wherein sending the information to the UE comprises:
sending a speed threshold to the UE through a SIB message or RRC signaling.

20-23. (canceled)

24. A communication apparatus, comprising a processor and a memory, wherein the memory stores a computer program, and the processor executes the computer program stored in the memory to enable the apparatus to perform a method for timing adjustment, comprising:
obtaining information sent by a network device;
determining a timing adjustment scheme based on the information; and
adjusting an uplink transmission timing of the UE based on the timing adjustment scheme.

25. A communication apparatus, comprising a processor and a memory, wherein the memory stores a computer program, and the processor executes the computer program stored in the memory to enable the apparatus to perform the method according to claim 13.

26-27. (canceled)

28. A non-transitory computer-readable storage medium, configured to store an instruction that, when executed, enables the method according to claim 1 to be implemented.

29. A non-transitory computer-readable storage medium, configured to store an instruction that, when executed, enables the method according to claim 13 to be implemented.
